(19) United States
(12) Patent Application Publication
(10) Pub. No.: US 2014/0170414 A1
(43) Pub. Date: Jun. 19, 2014

(54) Heat-Sealing Cover Film For Packaging Electronic Components

(71) Applicants: Wei Xiang Zhang, Shanghai (CN); Shijun Shen, Shanghai (CN); Bing Huang, Shanghai (CN)

(72) Inventors: Wei Xiang Zhang, Shanghai (CN); Shijun Shen, Shanghai (CN); Bing Huang, Shanghai (CN)

(73) Assignee: 3M INNOVATIVE PROPERTIES COMPANY, St. Paul, MN (US)

(21) Appl. No.: 14/235,831

(22) PCT Filed: Sep. 1, 2011
(86) PCT No.: PCT/CN2011/079229

§ 371 Date: Jan. 29, 2014

(51) Int. Cl. C09J 7/02; B32B 33/00; B32B 27/08

(52) U.S. Cl. CPC C09J 7/0296; B32B 27/08; B32B 33/00; C09J 7/0242
USPC 428/336; 428/349; 428/335

(57) ABSTRACT

A cover film for heat-sealing to a carrier tape for carrying electronic components is described herein. The cover film comprises a polyester base layer, a first antistatic layer disposed on a first surface of the base layer, an intermediate bi-layer structure comprising a first intermediate layer and a second intermediate layer, the first intermediate layer disposed on a second surface of the base layer opposite the first antistatic layer, the second intermediate layer disposed on the first intermediate layer opposite the base layer, a second antistatic layer disposed on the second intermediate layer opposite the first intermediate layer, and a heat-sealing layer disposed on the second antistatic layer. In an exemplary aspect, the first intermediate layer comprises polyethylene and the second intermediate layer comprises a poly(vinyl acetate) copolymer and a polystyrene-butadiene) copolymer. In another exemplary aspect, the second antistatic layer comprises carbon nanotubes in a polyacrylate binder.

The present invention relates to a heat-sealing cover film invention for electronic component packaging applications. In particular, the cover tap can be heat sealed to a carrier tape to facilitate storage, transport and mounting of small electronic components

As electronic equipment is miniaturized, the storage, handling, and transport of electronic components become more important. Generally, the electronic components are transported to an assembly location in a carrier tape that has a plurality of embossed pockets formed therein to hold the electronic components. A cover film can be heat sealed continuously along the edges of the carrier tape to seal the electronic components within the pockets of the carrier tape. Conventional heat sealable cover film generally consists of a thermoplastic backing material, for example, a biaxially stretched polyester film.

The electronic components are mounted onto a printed circuit board (PCB) or other substrate during assembly of electronic equipment or sub-assemblies that will be used later to build electronic equipment. The cover film is removed from the carrier tape during this assembly process to expose the electronic components residing within the pockets of the carrier tape. The component is lifted from a pocket by automatic precision placement machines and mounted to the PCB or substrate being assembled.

The cover films must adhere sufficiently to the carrier tape to retain the electronic components in the pockets of the carrier tape during storage and transport but must also be removable with the application of a moderate peeling force. Thus, the peel adhesion of the carrier tape is one critical property of the cover film. If the force to remove the cover film from the carrier tape (e.g. peel strength) is too low, there is a chance that the cover film will come off of the filled carrier tape during the transportation and the electronic components will fall out of the pockets. Conversely, too high of a peel strength is also undesirable, because the carrier tape may vibrate when the cover film is removed and this vibration can cause the electronic components to be popped out of the pockets in the carrier tape. Thus, it is highly desirable to maintain the peel strength of the cover film within a defined, narrow range. Excessive lot-to-lot variations in the peel strength of the cover film can cause difficulties in using it in conjunction with automatic precision placement machines.

The manner in which the adhesive of the cover film behaves during removal is also important. It is important that the disposition of the adhesive after peeling be uniform. Uneven adhesive islands, adhesive spalls and free adhesive shards can become contaminants to the electronic equipment assembly process and can interfere with the mounting of the electronic components to a PCB or other substrate. The mechanism by which the cover film peels from the carrier tape can be classified as interfacial peeling type mechanism (i.e. adhesive failure between the carrier tape and the adhesive of the cover film), transfer type (i.e. adhesive failure between the cover film adhesive and the underlying structure of the cover film resulting in the transfer of the adhesive layer to the carrier tape, and cohesive failure wherein the adhesive is split between the cover film and the carrier tape after peeling.

In addition, electrostatic discharge events can be created when two materials are separated from one another such as when the cover film is peeled away or removed from the carrier tape or when the carrier tape is unwound off of a transport spool. An electrostatic discharge event can damage a sensitive components residing in a pockets of the carrier tape and is thus undesirable. Thus, providing a carrier film having an antistatic layer is desirable.

Additional important properties of the carrier film include the strength and flexibility of the film so that it will not break during removal, and low haze (i.e. less than about 30%) and high transparency (i.e. greater than about 75%) so that the components within the pockets of the carrier tape can be easily viewed prior to removal from the carrier tape.

The object of the invention is to develop a heat-sealing cover film or tape which has stable peel properties including sufficient peel strength, uniform adhesive transfer, and wherein the failure mechanism during peeling is an interfacial type mechanism. In addition, the cover film should have good antistatic performance, should not contaminate the electronic component contained within the pockets of the carrier tape and have a transparent appearance (i.e. high transmittance and low haze).

According to an exemplary aspect of the present invention, a cover film for heat-sealing to a carrier tape which has pocket for carrying electronic components. The cover film comprises a polyester base layer, a first antistatic layer disposed on a first surface of the base layer, an intermediate bi-layer structure comprising a first intermediate layer and a second intermediate layer, the first intermediate layer disposed on a second surface of the base layer opposite the first antistatic layer, the second intermediate layer disposed on the first intermediate layer opposite the base layer, a second antistatic layer disposed on the second intermediate layer opposite the first intermediate layer, and a heat-sealing layer disposed on the second antistatic layer. In an exemplary aspect, the first intermediate layer comprises polyethylene and the second intermediate layer comprises a poly(vinyl acetate) copolymer and a poly(styrene-butadiene) copolymer. In another exemplary aspect, the second antistatic layer comprises carbon nanotubes in a polyacrylate binder.

The heat-sealing cover film, disclosed herein, has an excellent electrostatic dissipation performance, a good optical performance, a good mechanical performance, as well as an excellent heat-sealing performance for the surfaces of the substrates of polycarbonate, polystyrene, polypropylene or the like which are common substrate materials used in electronic carrier tapes. The heat-sealing cover film of the current invention has many advantages, such as, a permanent antistatic performance for both sides of the film to help provide electrostatic discharge protection both when the electronic carrier tape is unwound from its carrier spool and when the cover film is removed from the carrier tape. The exemplary cover film also has a high light transmittancy and a low haze to allow visualization of the electronic components contained within the pockets of the carrier tape without having to remove the cover film from the carrier tape. The cover film also provides stable adhesion and removal performance allowing it to be used automatic precision placement machines. Finally, the heat seal layer of the exemplary cover film separates cleanly from the cover film upon removal from the carrier tape to provide a uniform and predictable surface on the carrier film.

The exemplary cover film can be bonded to a commercial pocketed carrier tape via a thermal bonding process. When the exemplary cover film is removed from the carrier tape, the cover film undergoes an interfacial failure between the second antistatic layer and the second intermediate layer. This removal mechanism allows the heat seal layer and the second antistatic layer transfer uniformly to the carrier tape when the cover film is separated from the carrier tape.

The above summary of the present invention is not intended to describe each illustrated embodiment or every implementation of the present invention. The figures and the detailed description that follows more particularly exemplify these embodiments.

### SHORT DESCRIPTION OF THE FIGURES

The invention will now be described in more detail with reference to the following Figures, exemplifying particular embodiments of the invention.

FIG. 1 is a cross-sectional view of a heat-sealing cover film according to the current invention.

FIG. 2 is a photograph showing the uniform removal of the exemplary cover film of the current invention from the surface of a component carrier tape.

FIG. 3 is a photograph showing the tearing of the heat seal layer of a comparison cover film from the surface of a component carrier tape.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE FIGURES

In the following Detailed Description, reference is made to the accompanying drawings, which form a part hereof, and in which is shown by way of illustration specific embodiments in which the invention may be practiced. The following detailed description, therefore, is not to be taken in a limiting sense, and the scope of the present invention is defined by the appended claims.

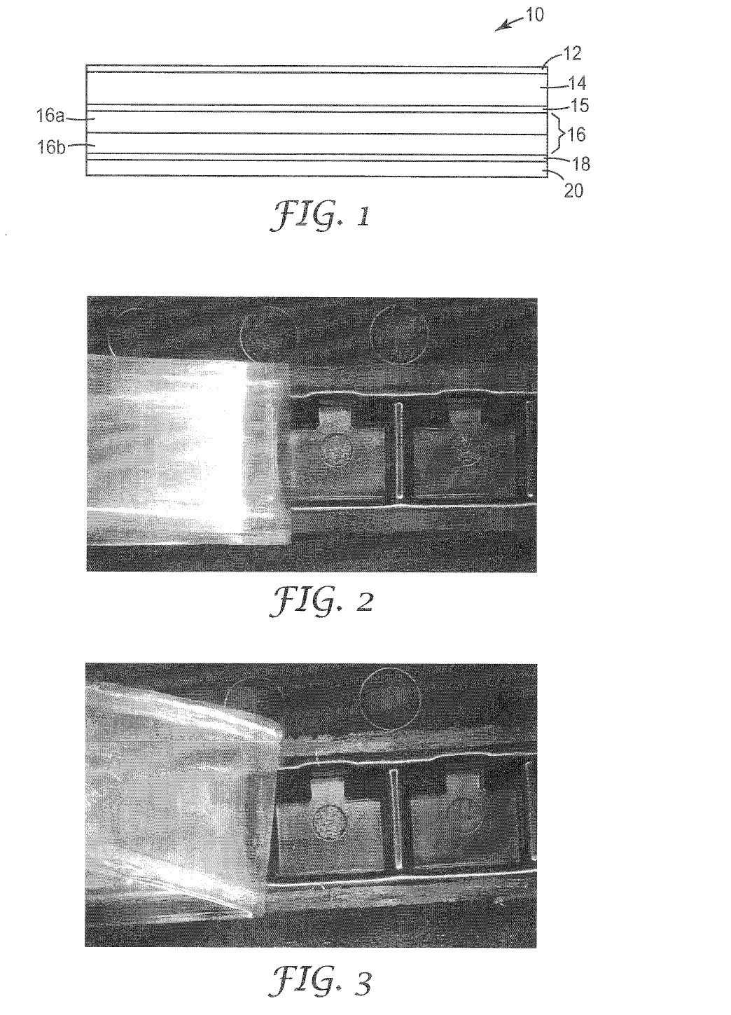

FIG. 1 is a schematic cross-sectional view of a cover film 10 according to the invention. The cover film includes a base layer 14 which provide a major contribution to the overall mechanical strength of the cover film. Base layer 14 has two generally parallel planar major surfaces. The base layer can be selected from biaxial stretched polyesters, polyolefins or nylons.

The base layer can have a thickness of about 10 microns to about 30 microns or more preferably of about 12 microns to about 20 microns. Additionally, the base layer can have an optical transmittance not less than 85%, and a tensile strength not less than 50 MPa.

A first antistatic layer 12 can be formed on one of the major surfaces of base layer 14. The base layer can coated with an antistatic coating which forms the first antistatic layer having a dry film thickness of about 0.001 microns to about 0.5 microns and more preferably between 0.01 microns and 0.1 microns. A thicker first antistatic layer can create a debris issue when sealing and removing the cover film from a carrier tape while too thin of a layer will not provide adequate antistatic performance. The first antistatic layer will also have a surface resistivity of about 1×10⁶ ohm/□ to about 1×10¹² ohm/□, preferably between about 1×10⁹ ohm/□ and about 1×10¹² ohm/□. The antistatic coating for the first antistatic layer can be coated on base layer 14 by a gravure coating process or other conventional low viscosity coating process. The antistatic coating for the first antistatic coating can comprise a conductive polymer coating such as an addition type cationic antistatic coating or a polymer grafting type cationic antistatic agent coating. Exemplary suitable conductive polymers include, but are not limited to polyacetylene, polypyrrole, polythiophene, polyaniline, polyether amides-based or polyester amides-based intrinsic antistatic polymers or the like, or combinations thereof Alternatively, antistatic coating for the first antistatic coating can comprise a conductive filler or salt dispersed in a solvent suspended polymeric binder or bound to a polymeric binder delivered in either a neat form or as a solvent dispersion. Exemplary conductive fillers include metal oxides, carbon nanotubes or other conductive particles. An exemplary conductive salt can be a tetravalent ammonium salt.

An intermediate bi-layer structure 16 can be disposed adjacent to the second major surface of base layer 14 opposite the first antistatic layer 12. The intermediate bi-layer structure comprises a first intermediate layer 16a and a second intermediate layer 16b. The intermediate bi-layer structure can be made by coextrusion and blow-forming process. The intermediate bi-layer structure can have a thickness of about 30 microns to about 50 microns.

The first intermediate layer 16a of cover film 10 is relatively soft and can comprise of a polyolefin film. In particular, the first intermediate layer can be a linear low density polyethylene (LLDPE) or a low density polyethylene film. In an exemplary aspect the LDPE film can with a weight-average molecular weight above 100,000 and a melt index (190° C., 2.16 kilograms, ASTM D1238) of 1-100 g/10 minutes, preferably about 2-10 g/10 minutes. The first intermediate layer of the intermediate bi-layer structure can have a thickness of about 10 microns to about 50 microns, preferably from about 20 microns to about 30 microns.

The second intermediate layer 16b can comprise a vinyl acetate copolymer, a styrene-butadiene copolymer or blend thereof. The second intermediate layer of the intermediate bi-layer structure can have a thickness of about 5 microns to about 20 microns, preferably from about 8 microns to about 15 microns.

A suitable vinyl acetate copolymer can be a copolymer between vinyl acetate and an olefin monomer. In an exemplary aspect, vinyl acetate copolymer has a molar percentage of the vinyl acetate (VA)-derived units of at least 10%, and more preferably above 20%. In another aspect, the exemplary polyolefin monomer is ethylene. Suitable vinyl acetate copolymers have a melt index (190° C., 2.16 kilograms, ASTM D1238) of 1-100 g/10 minutes.

A suitable styrene-butadiene copolymer applicable to the intermediate layer is preferably a block copolymer wherein the styrene-derived units comprise above 60 mole %, and more preferably above 70 mole % of the total units of the copolymer. Preferably, the suitable styrene-butadiene copolymer has a weight-average molecular weight of preferably about 40,000 to about 300,000, and more preferably about 50,000 to about 150,000, as well as a molecular weight distribution of preferably 1-2.

According to some embodiments, the second intermediate layer can be a polymer alloy formed by blend-extruding the ethylene-vinyl acetate copolymer and the styrene-butadiene block copolymer. In an exemplary aspect, the intermediate bi-layer structure 16 will comprise 25% to 55% of the vinyl acetate copolymer and 45% to 75% of the styrene-butadiene copolymer.

In an exemplary aspect the intermediate bi-layer structure 16 can be formed directly on the surface of the base layer or be laminated to the surface of the base layer.

In an alternative aspect, intermediate bi-layer structure 16 can be bonded to the surface of the base layer using an adhesive. A thin curable adhesive layer can be placed between the base layer and the intermediate bi-layer structure. Application of a moderate pressure and heat can be used to laminate the layers together. The resulting adhesive layer will typically have a thickness between about 0.5 microns and about 5 microns thickness, more preferably between about 1 micron and about 2 microns. The adhesive needs to provide sufficient holding strength to reliably adhere the intermediate bi-layer structure to the base layer, but too thick of an adhesive layer can result in reduce the cosmetic appearance of the cover film. An exemplary adhesive for bonding the intermediate bi-layer structure 16 to base layer 16 can be curable polyurethane type adhesive.

A second antistatic layer 18 is dispose adjacent to the second intermediate layer 16a of intermediate bi-layer structure 16 opposite base layer 14. The second antistatic layer can be comprised of carbon nanotubes in a polymeric binder. An aqueous solution of the carbon nanotubes and the polymeric binder can be applied to the surface of the second intermediate layer of the intermediate bi-layer structure by a gravure roll coating method or other conventional liquid coating method. After drying, the resulting thickness of the second antistatic layer 18 can be from about 0.1 microns to about 1 micron, more preferably between about 0.2 microns and about 0.6 microns. The carbon nanotubes composition of the second antistatic layer is from about 0.5 wt. % to about 3 wt. % in the polymer binder (i.e. the polymer binder content is from about 97 wt. % to about 99.5 wt. %) based on the total dry coating weight of second antistatic layer.

Heat sealing layer 20 is coated on the second antistatic layer opposite the second intermediate layer 16b by a gravure roll coating method or other conventional liquid coating method. The heat-sealing layer is provided on the surface of the intermediate layer opposite to the base layer. This heat-sealing layer can be composed of a material selected from polyacrylate, polymethyl methacrylates, polybutyl methacrylates or the copolymers thereof and having glass-transition temperature 30-100° C. and a heat activation temperature of at least 90° C.

In an exemplary aspect, the final cover film will be low haze (i.e. less than about 30%), or more preferably between 10% and about 30% and have high transparency (i.e. greater than about 75%) or more preferably between 75% and about 85%, so that the components within the pockets of the carrier tape can be easily viewed prior to removal from the carrier tape. The thickness of the heat sealing layer should be from about 0.01 microns to about 10 microns, more preferably between about 0.1 microns and about 1 micron.

The heat-sealing film, disclosed herein, has an excellent electrostatic dissipation performance, a good optical performance, a good mechanical performance, as well as an excellent heat-sealing performance for the surfaces of the substrates of polycarbonate, polystyrene, polypropylene or the like which are common substrate materials used in electronic carrier tapes. The heat-sealing cover film of the current invention has many advantages, such as, a permanent antistatic performance for both sides of the film to help provide electrostatic discharge protection both when the electronic carrier tape is unwound from its carrier spool and when the cover film is removed from the carrier tape. The exemplary cover film also has a high light transmittancy and a low haze to allow visualization of the electronic components contained within the pockets of the carrier tape without having to remove the cover film from the carrier tape. The cover film also provides stable adhesion and removal performance allowing it to be used automatic precision placement machines. Finally, the heat seal layer of the exemplary cover film separates cleanly from the cover film upon removal from the carrier tape to provide a uniform and predictable surface on the carrier film.

### Examples

### Test Methods:

Surface resistivity: The electrostatic discharge (ESD) behavior of the cover film was characterized according to ANSI ESD S11.11 “Surface Resistance Measurement of Static Dissipative Planer Materials” Test Method. A concentric ring electrode was used to measure the surface resistance of cover film. The resistance was measured using a Trek Model 152 Resistance Meter available from TREK, Inc. (Tokyo, Japan).

The electrode was placed on the surface to be measured. The appropriate test voltage was selected (i.e. 10 V or 100 V). The test button was pressed and the measured value for the surface resistivity was read from the LCD display. The unit of the surface resistivity is ohm/□.

Optical transmittance and haze: The optical transmittance and haze properties of the cover film were measured by a haze meter HM-150 available from Murakami Color Research Laboratory (Tokyo, Japan) according to ASTM Standard D-1003 “Standard Test Method for Haze and Luminous Transmittance of Transparent Plastics”. A piece of the material to be measured is placed in the haze meter and the results measured.

180° Peel Adhesion: Initial values of peel adhesion of the exemplary cover film to 3M™ Conductive Polycarbonate Carrier 3000 available from 3M Company (Austin, Tex., U.S.A.) were made by bonding a pristine sample of the exemplary cover film to a small roll of the cover tape using a conventional heat sealing machine. The sealing temperature was 160° C. A sealing pressure of 1.5 bar was applied for 50 ms. A 5.4 mm-wide×200 mm-long sample of the cover film/carrier tape composite was used for each peel adhesion test. The cover film was removed at 300 mm/min using 180° peel and the peel force was measured by a PT-45 Peel Force Tester available from V-Tek, Inc. (Mankato, Minn., U.S.A.). Five samples were tested and the average initial peel strength was calculated.

### Materials:

| | Trade Name or | |
|---|---|---|
| General description | Designation | Vendor Name |
| styrene-butadiene copolymer | Clear KIBTRON PB-5903 | Chi Mei Corp (Taiwan) |
| ethylene-vinyl acetate copolymer | ELVAX 260 resin | DuPont Company |
| resin (28% VA comonomer) | | (Wilmington, DE, U.S.A.) |
| Polyester film | ShenDa | Jiangsu Shenlong High- |
| | | technique Group Stock Co., Ltd. |
| | | (China) |
| low density polyethylene resin | 2420H | ExxonMobil Chemical Company |
| | | (Houston, TX, U.S.A.) |
| 1:1 Mixture of Pentaerythritol- | Antioxidant PW-9225 | Shanghai Albemarle Fine |
| tetra-[β-(3,5-di-tert-butyl-4- | | Chemical Co., Ltd |
| hydroxyphenyl)-propionate] and | | (Shanghai, China) |
| Bis(2.4-di-t-butylphenyl) | | |
| Pentaerythritol Diphosphite | | |
| polyurethane lamination | Takelac A-969V/Takenate | Takeda Chemical Industries |
| adhesive (polyfunctional | A-5 | (Osaka, Japan) |
| polyol/isocyanate) | | |
| anionic acrylic emulsion | NeoCryl A-1131 | DSM (Heerlen, Netherlands) |
| Aqueous dispersion of carbon | AQUACYL ™ AQ0101 | Nanocyl S.A. |
| nanotubes | Multi-Wall Carbon | (Sambreville, Belgium) |
| | Nanotube Aqueous | |
| | Dispersion | |
| Trisiloxane leveling agent | CoatOSil 77 | Momentive Performance |
| | | Materials Inc. (Shanghai, China) |
| Antistatic acrylic polymer | COLCOAT NR-121X-9 | Coalcaot Co., Ltd. |
| solution | | (Tokyo, Japan) |
| containing a tetravalent | | |
| ammonium salt | | |
| Thermoplastic conductive | STATNOVA ™ PNC300 | Polynova Materials Suzhou |
| polymer compound | | (Suzhou, China) |

Preparation of the material for the second intermediate layer: 60 kg of a styrene-butadiene block copolymer (KIBTRON PB-5903), 40 kg of a poly(vinyl acetate) (Elvax 260), and 0.4 kg of Antioxidant PW-9225 were melt mixed at 180° C. to form a uniform mixture. The resulting mixture was cooled and granulated for later use. Thus, this exemplary second intermediate layer comprises about 60 wt. % of the styrene-butadiene block copolymer and about 40 wt. % poly(vinyl acetate).

Formation of the intermediate bi-layer structure: The prepared material for the second intermediate layer and low density polyethylene (2420H) were coextruded and formed into a bi-layer film. The intermediate bi-layer structure or film had a total thickness of 38 μm, wherein the thickness of the first intermediate layer (e.g. the polyethylene layer) was 26 μm and the thickness of the second intermediate layer (e.g. the SBS-vinyl acetate layer) was 12 μm.

Preparation of the coating for the second antistatic layer: 8 kg of a 1% aqueous dispersion of carbon nanotubes (AQUACRYL™ AQ0101) was mixed with 10 kg of polyacrylic emulsion (A-1131) for about 5 minutes. Then 22.8 kg deionized water and 200 grams leveling agent (Coatosil 77) was added into the mixed solution, and stirred for additional 5 minutes. The mixture was set aside until it defoamed.

Preparation of the material for the heat sealing layer: 5 kg of a 40 wt. % polymethyl methacrylate/butyl methacrylate copolymer solution in ethyl acetate was diluted with 15 kg of a solvent of ethyl acetate available from Shanghai Chemical Reagent Co., Ltd. (Shanghai, China) and stirred for 5 minutes. The exemplary polymethyl methacrylate/butyl methacrylate copolymer used in this example contains about 60% methyl methacrylate units and about 40% butyl methacrylate and has a molecular weight of about 120,000 with a molecular weight distribution is 2.5. The resulting heat sealing layer solution had a 10% acrylic resin solid content. The class transition temperature of the resulting heat sealing layer material is about 80° C.

Constructing the exemplary cover film: A 12μm-thick single side corona discharge treated biaxial stretched polyester thin film was used as the base layer for the cover film.

The corona discharge treated surface of the polyester film was coated with a polyurethane adhesive comprising a polyfunctional polyol and an isocyanate (Takelac A-969V/Takenate A-5) at a 3:1 mix ratio. The adhesive film was baked to dry the coating and/or initiate the cure of the polyurethane adhesive and then laminated to the first intermediate layer of the intermediate bi-layer structure. The adhesive was gravure roll coated to yield an about 1 μm thick adhesive layer after baking. After lamination, the polyurethane adhesive was cured at room temperature.

The second antistatic layer coating solution was coated on the exposed surface of the second intermediate layer of the intermediate bi-layer structure and was dried in an oven to remove the water (solvent). The dry second antistatic layer had a thickness of about 0.4 μm and had a surface resistivity of 1×10⁷ ohm/□.

The heat sealing layer solution was coated on the surface second antistatic layer and dried in an oven to remove the solvent. The resulting dry heat sealing adhesive layer had a thickness of about 0.4 μm and had a surface resistivity of 1×10⁹ ohm/□.

The first antistatic layer coating solution with a solid content of 1% COLCOAT NR-121X-9 was coated on to the uncoated surface of the base layer (e.g. the PET film) opposite the intermediate bi-layer structure, and dried in an oven yielding the final heat sealing cover film. The resulting first antistatic layer had a dry film thickness of about 0.04 μm and a surface resistivity of 1×10¹¹ ohm/□ under an environment of normal temperature and normal humidity.

The heat-sealing cover film had an optical transmittance thereof was 82% and a haze value of 15%. The surface resistivity on the surface of the heat sealing layer adjacent to the second antistatic layer was 1×10⁹ ohm/□, and the surface resistivity of the first antistatic layer was 1×10¹¹ ohm/□. The cover film was slit to an appropriate width and sealed onto a carrier tape at 170° C., the average peel force was 45±3 g with a range of about 35 g to about 55 g for the given sample. When the cover film was peeled off from the carrier tape, the heat-sealing layer and second antistatic layer transferred uniformly to the carrier tape. Thus, the cover film experienced an interfacial failure between the surface of the second intermediate layer and the surface of the second antistatic layer.

FIG. 2 shows the uniform removal of the exemplary cover film of the current invention from the surface of a component carrier tape. In this example, the cover film exhibits an interfacial adhesion failure between the second antistatic layer and the second intermediate layer. There is no tearing or spalling of the heat seal layer material which is highly desired in a cover film for an electronic component carrier tape.

### Comparative Example

In the comparison example, the second conductive layer is effectively combined into the second intermediate layer to produce a single functional layer instead of two separate layers.

Preparation of the material for the functional layer: 67.5 kg of a styrene-butadiene block copolymer (PB-5903), 37.5 kg of a poly(vinyl acetate) (Elvax 260), 45 kg of an intrinsic antistatic polymer (IDP: PolyNova PNC300R-M) and 0.6 kg of an antioxidant AS (Jinhai Albemarle, Shanghai Jinhai Albemarle Fine Chemicals Co, Ltd.) were melt mixed at 180° C. to form a uniform mixture. The resulting mixture was cooled and granulated for later use.

Formation of the intermediate bi-layer structure: The prepared material for the functional layer and low density polyethylene (2420H) were coextruded and formed into a bi-layer film. The intermediate bi-layer structure or film had a total thickness of 38 μm, wherein the thickness of the first intermediate layer (e.g. the polyethylene layer) was 26 μm and the thickness of the functional layer (e.g. the conductive SBS-vinyl acetate layer) was 12 μm. The surface resistivity of functional layers was 1×10⁹ ohm/□.

Preparation of the material for the heat sealing layer: 5 kg of a 40 wt. % polymethyl methacrylate/butyl methacrylate copolymer solution, with a copolymer glass-transition temperature of 80° C. The solution was further diluted with 15 kg of ethyl acetate, and then 2 kg of toluene was added. The exemplary polymethyl methacrylate/butylmethacrylate copolymer used in this comparative example contains about 60% methyl methacrylate units and about 40% butyl methacrylate and has a molecular weight of about 120,000 with a molecular weight distribution of 2.5. The diluted solution was then stirred for an additional 5 minutes. The solid content of acrylic heat seal layer coating solutions in the solution was 10%.

Constructing the comparison cover film: A 12 μm-thick single side corona discharge treated biaxial stretched polyester thin film was used as the base layer for the cover film.

The corona discharge treated surface was coated with a polyurethane adhesive comprising a polyfunctional polyol and an isocyanate (Takelac A-969V/Takenate A-5) at a 3:1 mix ratio. The adhesive film was baked to dry the coating and/or initiate the cure of the polyurethane adhesive and then laminated to the first intermediate layer of the intermediate bi-layer structure (i.e. the PE surface of the intermediate bi-layer structure). The adhesive was gravure roll coated to yield an about 1 μm thick adhesive layer after baking. After lamination, the polyurethane adhesive was cured at room temperature.

The acrylic heat seal layer coating solution was coated on the free surface of the functional layer and was dried in an oven to remove the solvent. The acrylic resin layer was the heat sensitive adhesive layer, which had a thickness of about 0.4 μm and had a surface resistivity of 1×10¹⁰ ohm/□.

The antistatic layer coating solution with a solid content of 1% COLCOAT NR-121X-9 was coated on to the uncoated surface of the base layer (e.g. the PET film) opposite the intermediate bi-layer structure, and dried in an oven yielding the final heat sealing cover film. The resulting first antistatic layer had a dry film thickness of about 0.04 μm and a surface resistivity of 1×10¹¹ ohm/□ under an environment of normal temperature and normal humidity.

The optical transmittance of the comparison heat seal film was 85%. The comparison heat seal film had a haze value of was 10% and a surface resistivity on the surface of the heat sealing material of was 1×10¹⁰ ohm/□. The surface resistivity of the antistatic layer disposed against the base layer was 1×10¹¹ ohm/□.

The heat seal film of the comparative example was slit to a width slightly greater than the carrier tape to which it was bonded. The cover film was slit to an appropriate width and sealed onto a carrier tape at 170° C., the average peel force was 52±3g with a range of about 40 g to about 64 g for the given sample. When the cover film was removed from the carrier tape, the cover film experienced cohesive failure in at least a portion resulting in an uneven transfer of the adhesive to the carrier tape and the formation of random spalls and tears in the adhesive which could result in debris formation during electronic component assembly.

FIG. 3 shows how the sealing layer tears when it is separated from an exemplary component carrier tape to which it has been bonded. Thus, the sealing layer exhibits a cohesive failure mechanism which is undesirable for the target application of the sealing film.

The present invention should not be considered limited to the particular example described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A cover film for heat-sealing to a carrier tape which has pockets for carrying electronic components, the cover film comprising:
a polyester base layer;
a first antistatic layer disposed on a first surface of the base layer;
an intermediate bi-layer structure comprising a first intermediate layer and a second intermediate layer, wherein the first intermediate layer is disposed on a second surface of the base layer opposite the first antistatic layer and comprises polyethylene and wherein the second intermediate layer is disposed on the first intermediate layer opposite the base layer and comprises a poly(vinyl acetate) copolymer and a poly(styrene-butadiene) copolymer;
a second antistatic layer disposed on the second intermediate layer opposite the first intermediate layer and comprising carbon nanotubes in a polyacrylate binder; and
a heat-sealing layer disposed on the second antistatic layer opposite the second intermediate layer.

2. The cover film of claim 1, wherein the first antistatic layer comprises an antistatic polymer or a conductive polymer.

3. The cover film as claimed in claim 2, wherein the conductive polymer is selected from the group consisting of polyacetylene, polypyrrole, polythiophene, polyaniline, polyether amide-based or polyester amide-based intrinsic antistatic polymers, or combinations thereof.

4. The cover film as claimed in claim 2, where the antistatic polymer is an acrylic polymer containing a tetravalent ammonium salt.

5. The cover film as claimed in claim 1, wherein the base layer has a thickness of about 10 μm to about 30 μm.

6. The cover film as claimed in claim 1, wherein the base layer has an optical transmittance not less than 85%, and a tensile strength not less than 50 MPa.

7. The cover film as claimed in claim 1, wherein in the vinyl acetate copolymer, the units derived from vinyl acetate at least comprise 10% by mole of the copolymer.

8. The cover film as claimed in claim 1, wherein the styrene-butadiene copolymer is a block copolymer.

9. The cover film as claimed in claim 1, wherein the vinyl acetate copolymer comprises 25-55% by weight of the total weight of the second intermediate layer.

10. The cover film as claimed in claim 1, wherein the styrene-butadiene copolymer comprises 45-75% by weight of the total weight of the second intermediate layer.

11. The cover film as claimed in claim 1, wherein the vinyl acetate copolymer is a copolymer of vinyl acetate and ethylene.

12. The cover film as claimed in claim 1, wherein the intermediate bi-layer structure has a thickness from about 30 μm to about 50 μm.

13. The cover film as claimed in claim 1, wherein the polyethylene of the first intermediate layer has a weight average molecular weight of 100,000-1,000,000.

14. The cover film as claimed in claim 1, wherein the polyethylene of the first intermediate layer has a melt index of 1-10 g/10 minutes.

15. The cover film as claimed in claim 1, wherein the first intermediate layer has a thickness of 20-30 μm.

16. The cover film as claimed in claim 1, wherein the heat-sealing layer has a thickness of 0.1 μm to

17. The cover film as claimed in claim 1, wherein the heat-sealing layer disposed over the second antistatic layer has a surface resistivity of 1×10⁷ ohm/□−1×10¹² ohm/□.

18. The cover film as claimed in claim 1, wherein the heat seal layer has a glass transition temperature of 30° C.-100° C.

19. The cover film as claimed in claim 1, wherein the heat-sealing layer comprises a poly(methyl methacrylate/butyl methacrylate) copolymer.

20. The cover film as claimed in claim 19, wherein the poly(methyl methacrylate/butyl methacrylate) copolymer has a glass transition temperature of about 80° C.

21. The cover film as claimed in claim 19, wherein the poly(methyl methacrylate/butyl methacrylate) copolymer comprises 60% methyl methacrylate units and 40% butyl methacrylate units.

22. The cover film as claimed in claim 1 further comprising a curable adhesive layer disposed between the first intermediate layer and the base layer.

23. The cover film as claimed in claim 1, wherein the first antistatic layer has a thickness of 0.01 μm to 0.1 μm.

24. The cover film as claimed in claim 1, wherein the first antistatic layer has a surface resistivity of 1×10⁹ to 1×10¹² ohm/□.

25. The cover film as claimed in claim 1, wherein the cover film undergoes interfacial failure between the second antistatic layer and the second intermediate layer when it is separated from the carrier tape to which it has been heat sealed.

26. The cover film as claimed in claim 25, wherein the heat seal layer and the second antistatic layer transfer uniformly to the carrier tape when the cover film is separated from the carrier tape.
